(19) United States
(12) Patent Application Publication
(10) Pub. No.: US 2024/0020821 A1
(43) Pub. Date: Jan. 18, 2024

(54) DEFECT INSPECTION DEVICE, DEFECT INSPECTION METHOD, AND DEFECT INSPECTION COMPUTER PROGRAM PRODUCT

(71) Applicant: Kabushiki Kaisha Toshiba, Tokyo (JP)

(72) Inventor: Akira MORIYA, Kawasaki Kanagawa (JP)

(21) Appl. No.: 18/179,169

(22) Filed: Mar. 6, 2023

(30) Foreign Application Priority Data
Jul. 15, 2022 (JP) 2022-114214

(51) Int. Cl. G06T 7/00; G06V 10/24

(52) U.S. Cl. CPC G06T 7/001; G06V 10/245; G06T 2207/30108

(57) ABSTRACT

According to one embodiment, a defect inspection device includes an acquisition unit, an evaluation-target-image-generation unit, a defect-estimation-image-generation unit, and an iteration-control unit. The acquisition unit acquires an inspection image obtained by imaging an inspection target and a reference image of the inspection target in design. The evaluation-target-image-generation unit generates an evaluation target image according to the reference and inspection images. The defect-estimation-image-generation unit generates a defect estimation image with a defect estimation value being defined for each pixel based on a feature of a defect candidate area corresponding to an image area of consecutive pixels each of which has a pixel value equal to or greater than a first threshold value and which are included in the evaluation target image. The iteration-control unit controls the defect-estimation-image-generation unit to iterate defect estimation image generation processing using the defect estimation image as the evaluation target image.

### CROSS-REFERENCE TO RELATED APPLICATIONS

This application is based upon and claims the benefit of priority from Japanese Patent Application No. 2022-114214, filed on Jul. 15, 2022; the entire contents of which are incorporated herein by reference.

### FIELD

Embodiments described herein relate generally to a defect inspection device, a defect inspection method, and a defect inspection computer program product.

### BACKGROUND

Systems for which inspection images obtained by imaging inspection targets, such as semiconductor mask patterns and printed circuit boards, are used to determine defect areas of the inspection targets have been known. For example, a technique of comparing an inspection image with a reference image of the inspection target in design, and determining a defect area based on a change in edge shapes in the image has been disclosed. In addition, a technique of generating a multidimensional feature image by applying multiple filter processes to an inspection image and detecting a defect from the multidimensional feature image has been disclosed.

However, in the determination technique based on the change in the edge shapes, patterns and shapes of the defects to be determined are limited. As such, it is difficult to determine defect areas included in an inspection image that includes defects and patterns of shapes other than those to be determined. Furthermore, by the technique using multidimensional feature images, there are cases where quasi-defects that are not defects are detected as defects due to the influence, for example, by noise included in the inspection image, and detection conditions. In other words, it is difficult to inspect defect areas with high accuracy by the related technologies.

### BRIEF DESCRIPTION OF THE DRAWINGS

FIG. 1 is a block diagram illustrating a defect inspection device;

FIG. 2A is a schematic diagram illustrating a reference image;

FIG. 2B is a schematic diagram illustrating an inspection image;

FIG. 3A is an explanatory diagram illustrating a pattern area;

FIG. 3B is a schematic diagram illustrating a reference image;

FIG. 4 is an explanatory diagram illustrating an evaluation target image;

FIG. 5A is an explanatory diagram illustrating specifying of defect candidate areas;

FIG. 5B is an explanatory diagram illustrating specifying of defect candidate areas;

FIG. 5C is an explanatory diagram illustrating specifying of defect candidate areas;

FIG. 6A is a schematic diagram illustrating a defect estimation image;

FIG. 6B is a schematic diagram illustrating a defect estimation image;

FIG. 7 is a flowchart illustrating a flow of information processing; and

FIG. 8 is a diagram illustrating a hardware configuration.

### DETAILED DESCRIPTION

A defect inspection device according to an embodiment includes one or more hardware processors configured to function as an acquisition unit, an evaluation target image generation unit, a defect estimation image generation unit, and an iteration control unit. The acquisition unit acquires an inspection image obtained by imaging an inspection target and a reference image of the inspection target in design. The evaluation target image generation unit generates an evaluation target image in accordance with the inspection image and the reference image. The defect estimation image generation unit generates, based on a feature of a defect candidate area corresponding to an image area of consecutive pixels each of which has a pixel value equal to or greater than a first threshold value and which are included in the evaluation target image, a defect estimation image for which a defect estimation value is defined for each pixel. The iteration control unit controls the defect estimation image generation unit to perform iteration of defect estimation image generation processing using the defect estimation image as the evaluation target image.

A defect inspection device, a defect inspection method, and a defect inspection computer program product according to the present embodiment will be described in detail below with reference to the accompanying drawings.

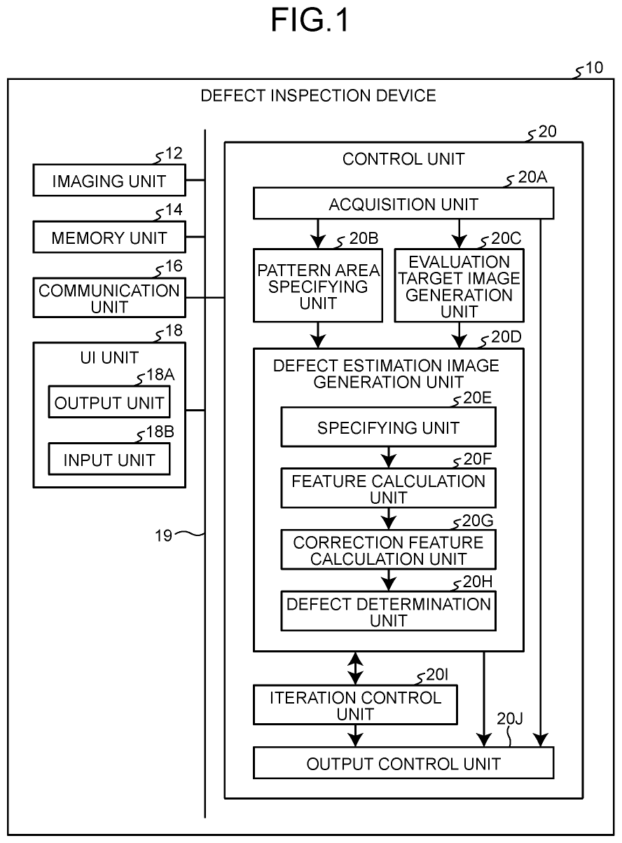

FIG. 1 is a block diagram illustrating an example of a configuration of a defect inspection device 10 of the present embodiment.

The defect inspection device 10 is an information processing device for inspecting defect areas included in an inspection image by using the inspection image obtained by imaging an inspection target. Details of the inspection target and the inspection image are described later.

The defect inspection device 10 includes an imaging unit 12, a memory unit 14, a communication unit 16, a user interface (UI) unit 18, and a control unit 20. The imaging unit 12, the memory unit 14, the communication unit 16, the UI unit 18, and the control unit 20 are communicatively connected via a bus 19 and other means.

The imaging unit 12 acquires imaged image data by imaging. Hereinbelow, the imaged image data will be referred to as an imaged image and will be described. The memory unit 14 stores various types of information.

The communication unit 16 is a communication interface for communicating with an information processing device external to the defect inspection device 10. For example, the communication unit 16 communicates with external information processing devices or electronic devices via a wired network such as Ethernet (registered trademark), a wireless network such as Wireless Fidelity (Wi-Fi) or Bluetooth (registered trademark), or other networks.

The UI unit 18 includes an output unit 18A and an input unit 18B.

The output unit 18A outputs various types of information. The output unit 18A is, for example, a display unit, which is a display, a speaker, a projection device, or the like. The input unit 18B receives operation instructions from a user. The input unit 18B is, for example, a pointing device such as a mouse or a touchpad, a keyboard, or the like. The UI unit 18 may be a touch panel integrally formed with the output unit 18A and the input unit 18B.

The control unit 20 executes information processing in the defect inspection device 10. The control unit 20 includes an acquisition unit 20A, a pattern area specifying unit 20B, an evaluation target image generation unit 20C, a defect estimation image generation unit 20D, an iteration control unit 20I, and an output control unit 20J. The defect estimation image generation unit 20D includes a specifying unit 20E, a feature calculation unit 20F, a correction feature calculation unit 20G, and a defect determination unit 20H.

The acquisition unit 20A, the pattern area specifying unit 20B, the evaluation target image generation unit 20C, the defect estimation image generation unit 20D, the specifying unit 20E, the feature calculation unit 20F, the correction feature calculation unit 20G, the defect determination unit 20H, the iteration control unit 20I, and the output control unit 20J are implemented by, for example, one or more processors. For example, each of the above-described units may be implemented by causing a processor such as central processing unit (CPU) to execute a computer program, that is, by software. Each of the above-described units may be implemented by a processor such as dedicated IC, that is, by hardware. Each of the above-described units may be implemented with a combination of software and hardware. In a case in which a plurality of processors are used, each processor may implement one of the units or may implement two or more units.

A configuration in which at least one of the above-described units included in the control unit 20 is mounted in an external information processing device that is communicatively connected to the defect inspection device 10 via a network or other means may be employed. In addition, at least one piece of information out of various types of information stored in the memory unit 14 may be stored in an external memory device that is communicatively connected to the defect inspection device 10 via a network or other means. Furthermore, at least one of the imaging unit 12, the memory unit 14, and the UI unit 18 may be configured to be mounted in an external information processing device that is communicatively connected to the defect inspection device 10. In this case, a system including externally mounted components and the defect inspection device 10 may be configured as a defect inspection device system.

The acquisition unit 20A acquires an inspection image obtained by imaging an inspection target and a reference image of the inspection target in design.

The inspection target is an object subjected to defect inspection. For example, the inspection target is an object manufactured by a manufacturing system or other methods according to specifications represented by design data. Specific examples of the inspection target include patterned printed circuit boards, semiconductor mask patterns, metal plates, steel strips, and the like, but the inspection target is not limited thereto.

In the present embodiment, a form in which the inspection target is a semiconductor mask pattern will be described as an example. Furthermore, in the present embodiment, the form in which the inspection target is an object manufactured by a manufacturing system or other methods according to specifications represented by design data will be described as an example.

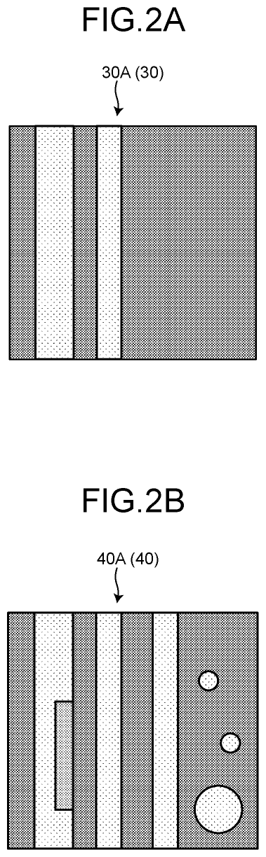

FIG. 2A is a schematic diagram illustrating an example of a reference image 30A. The reference image 30A is an example of a reference image 30.

The reference image 30 is an image of the inspection target in design. In other words, the reference image 30 is an ideal inspection target image that contains no defects or noise. As described above, in the present embodiment, the inspection target is manufactured by a manufacturing system or other methods according to specifications represented by design data. For example, an external information processing device generates virtual inspection target data for a two dimensional or three dimensional virtual inspection target that is virtually manufactured according to design data, and generates, as the reference image 30, an image of the virtual inspection target represented by the virtual inspection target data, the image being virtually imaged along a predetermined direction. The control unit 20 of the defect inspection device 10 may generate the reference image 30 in advance by using the design data. In the present embodiment, the form in which the reference image 30 that has been generated in advance is stored in the memory unit 14 will be described as an example.

FIG. 2B is a schematic diagram illustrating an example of an inspection image 40A. The inspection image is an example of an inspection image 40.

The inspection image 40 is an imaged image obtained by imaging the inspection target. A direction along which the inspection target is imaged corresponds to the above-described predetermined direction, which is a direction along which the virtual inspection target used to generate the reference image 30 is imaged. For example, the acquisition unit 20A acquires the inspection image 40 from the imaging unit 12. The acquisition unit 20A may also read the inspection image 40 from the memory unit 14 to acquire the inspection image 40. The acquisition unit may also acquire the inspection image 40 from an external information processing device via the communication unit 16.

In a case in which the inspection target is manufactured to faithfully reproduce the design data, and the inspection target does not contain defects such as adhesion of dust, damage, misalignment, or deformation, and a case in which the imaged image does not contain noise, the inspection image 40 and the reference image 30 are likely to be the same image. In practice, however, the inspection image 40 may contain defects or noise.

Therefore, the defect inspection device 10 of the present embodiment inspects a defect area representing defects included in the inspection image 40 with high accuracy.

Returning to FIG. 1, the explanation will be continued.

The pattern area specifying unit 20B specifies a pattern area included in the reference image 30.

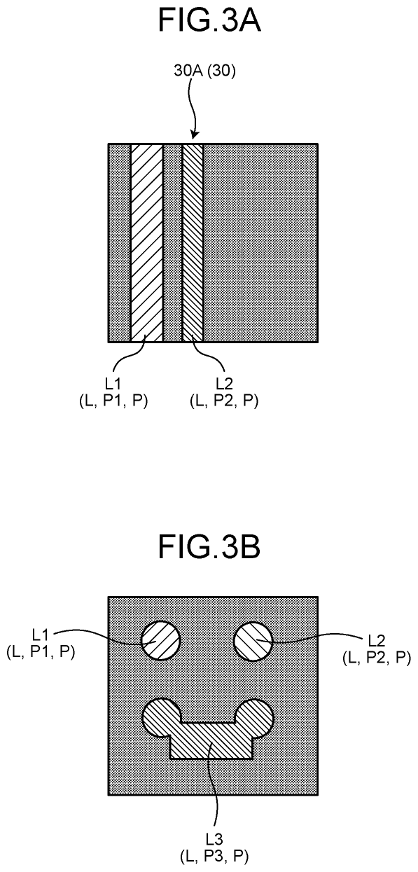

FIG. 3A is an explanatory diagram illustrating an example of specifying of pattern areas. FIG. 3A is a schematic diagram illustrating an example of the reference image 30A.

For example, the pattern area specifying unit 20B specifies, as a pattern area, an area of consecutive pixels each of which has a pixel value equal to or greater than a third threshold value and which are included in the reference image 30A. The third threshold value may be determined in advance. For example, the third threshold value may be determined in advance, according to specifications of the inspection target represented by the design data, inspection specifications of the inspection target, or the like. The third threshold value may be changed as needed according to operation instructions given to the UI unit 18 by the user.

In detail, the pattern area specifying unit 20B reads a pixel value of each of the pixels included in the reference image 30A. The pattern area specifying unit 20B then specifies, out of the pixels included in the reference image 30A and as a pattern area P, an area of consecutive pixels each of which has a pixel value equal to or greater than the third threshold value. The area of consecutive pixels means an area in the image where pixels are arranged to be adjacent and connected to each other. The pattern area P may be an area consisting of a group composed of one or more pixels, and is not limited to an area consisting of a plurality of the pixels.

In FIG. 3A, as an example, a state in which the pattern area specifying unit 20B specifies a pattern area P1 and a pattern area P2 as the pattern areas P is illustrated. The pattern area specifying unit 20B assigns a label L to each specified pattern area P, thereby carrying out labeling. In FIG. 3A, as an example, the form in which a label L1 is assigned to the pattern area P1, and a label L2 is assigned to the pattern area P2 is illustrated.

The labeling enables a position of each pattern area P to be specified in the reference image 30A. The position in the reference image 30A is represented by, for example, pixel positions of the individual pixels in the pattern areas P to which the labels L are assigned, a position coordinate of each of the pixels, the center coordinates of the pattern areas P, or the like.

For example, for each specified pattern area P, the pattern area specifying unit 20B stores, in the memory unit 14, the labels L and the pixel position or position coordinate of each of the pixels included in the pattern areas P to which the labels L are assigned in association with each other. The labels L of the pattern areas P may be treated as information that includes ID (identification information) of each label L and the pixel position or position coordinate of each of the pixels included in the pattern areas P. Each label L may be the information that further includes the center coordinate of the pattern area P, as described above.

In FIG. 3A, as an example, the form in which each pattern area P included in the reference image 30 has a rectangular shape is illustrated. However, the shape of each pattern area P included in the reference image 30 is not limited to a rectangle.

FIG. 3B is a schematic diagram illustrating an example of a reference image 30B. The reference image 30B is an example of the reference image 30. As illustrated in FIG. 3B, the reference image 30B may include pattern areas P having shapes other than rectangular, such as circular. In the case in which the pattern areas P having shapes other than a rectangle are included, the pattern area specifying unit 20B may specify the pattern areas P by the same process.

In FIG. 3B, as an example, a state in which the pattern area specifying unit 20B specifies the pattern area P1, the pattern area P2, and a pattern area P3 as the pattern areas P is illustrated. The pattern area specifying unit 20B assigns a label L to each specified pattern area P, thereby carrying out labeling. In FIG. 3B, as an example, the form in which the label L1 is assigned to the pattern area P1, the label L2 is assigned to the pattern area P2, and a label L3 is assigned to the pattern area P3 is illustrated.

Returning to FIG. 1, the explanation will be continued.

The evaluation target image generation unit 20C generates an evaluation target image in accordance with the reference image 30 and the inspection image 40.

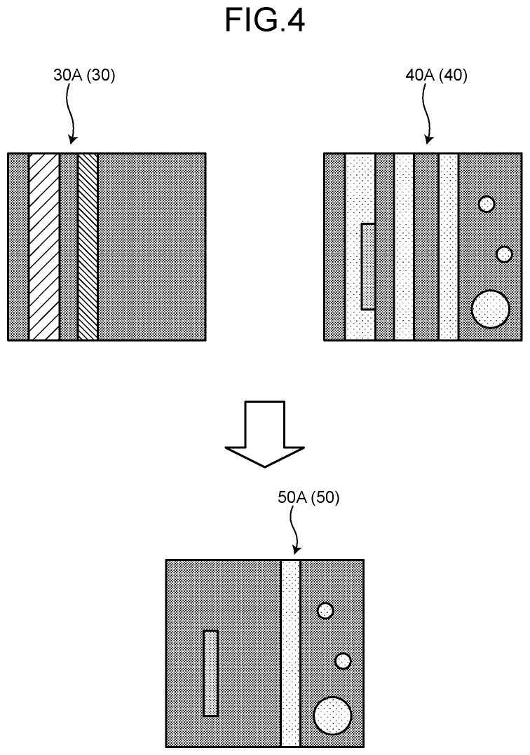

FIG. 4 is an explanatory diagram illustrating an example of the generation of an evaluation target image 50A. The evaluation target image 50A is an example of an evaluation target image 50.

The evaluation target image 50 is an image used as a target subjected to a defect evaluation for the inspection image 40. The evaluation target image generation unit 20C generates one evaluation target image from one reference image 30 and one inspection image 40. In detail, the evaluation target image generation unit 20C generates a difference image between the reference image 30 and the inspection image 40, or a composite image of the reference image 30 and the inspection image 40 as the evaluation target image 50.

The difference image is an image for which a difference between pixel values of a pixel value of each pixel constituting the reference image 30 and a pixel value of each pixel constituting the inspection image 40 for each same pixel position is defined pixel by pixel. The difference image may also be an image for which a value obtained after applying a predetermined weight value, carrying out saturation processing, and the like to this difference between the pixel values is defined for each pixel.

The composite image is an image for which a composite value of pixel values of a pixel value of each pixel constituting the reference image 30 and a pixel value of each pixel constituting the inspection image 40 at the same pixel position is defined pixel by pixel. The composite value may be obtained using an addition value, a multiplication value, a value obtained by applying weight or carrying out saturation processing to the addition value or the multiplication value, and other values.

In the present embodiment, the evaluation target image generation unit 20C will be described as an example of the form in which the difference image between the reference image 30 and the inspection image 40 is generated as the evaluation target image 50. A difference image between the reference image 30A and the inspection image is illustrated in FIG. 4 as the evaluation target image 50A.

In detail, the evaluation target image generation unit 20C calculates, for example, a difference between pixel values of a pixel value of each pixel constituting the reference image 30A and a pixel value of each pixel constituting the inspection image 40A at the same pixel position. The evaluation target image generation unit 20C then sets a set value H representing an “image dynamic range/2” as a pixel value of a pixel for which the difference between the pixel values is 0. The image dynamic range is a dynamic range of the reference image 30A or the inspection image 40A. The dynamic range of the reference image 30A and the dynamic range of the inspection image 40A will be described as the same ones.

In addition, the evaluation target image generation unit 20C performs saturation processing so that each difference between pixel values obtained by performing calculation for each pixel has a value within a range of 0 to the maximum pixel value −1 based on the above-described set value H in the case in which the difference between the pixel values is 0. Furthermore, the evaluation target image generation unit 20C sets the value obtained after performing saturation processing on the difference between the pixel values as a pixel value of the pixel at the corresponding pixel position. According to these processes, the evaluation target image generation unit 20C generates the evaluation target image 50.

Returning to FIG. 1, the explanation will be continued.

The defect estimation image generation unit 20D generates a defect estimation image for which a defect estimation value is defined for each pixel based on a feature of a defect candidate area corresponding to an image area of consecutive pixels each of which has a pixel value equal to or greater than a first threshold value included in the evaluation target image 50.

The defect estimation image generation unit 20D includes the specifying unit 20E, the feature calculation unit 20F, the correction feature calculation unit 20G, and the defect determination unit 20H.

The specifying unit 20E specifies the defect candidate area corresponding to the image area of consecutive pixels each of which has a pixel value equal to or greater than the first threshold value included in the evaluation target image 50.

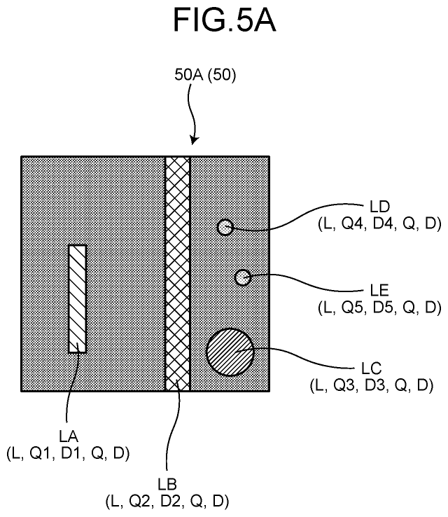

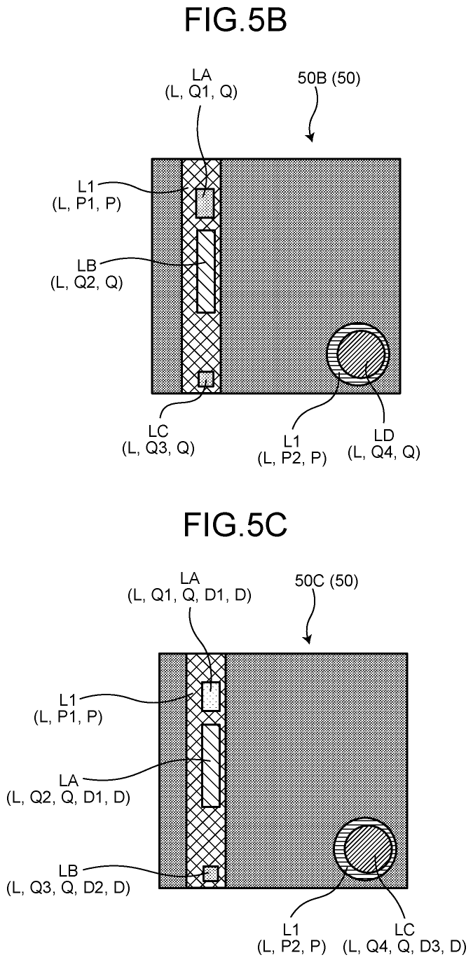

FIG. 5A is an explanatory diagram illustrating an example of specifying of defect candidate areas D, where the specifying is carried out by the specifying unit 20E. In FIG. 5A, the evaluation target image 50A is illustrated as an example.

The specifying unit 20E reads a pixel value of each of the pixels included in the evaluation target image 50A. The specifying unit 20E then specifies, out of the pixels included in the evaluation target image 50A, an image area Q of consecutive pixels each of which has a pixel value equal to or greater than the first threshold value. The image area Q may be an area consisting of a group composed of one or more pixels, and is not limited to an area consisting of a plurality of the pixels.

The first threshold value may be determined in advance. For example, the first threshold value may be determined in advance according to a type of the inspection target, the defect inspection accuracy required for the inspection target, a method of generating the evaluation target image 50A, and other conditions. The first threshold value may be changed as needed according to operation instructions given to the UI unit 18 by the user.

In FIG. 5A, a case in which the specifying unit 20E specifies image areas Q1 to Q5 as the image area Q included in the evaluation target image 50A is illustrated as an example.

For example, the specifying unit 20E specifies the specified image area Q as a defect candidate area D. In detail, a case in which the image areas Q1 to Q5 are respectively specified as defect candidate areas D1 to D5 is illustrated in FIG. 5A as an example.

The specifying unit 20E assigns a label L to each defect candidate area D that has been specified, thereby carrying out labeling. In FIG. 5A, a case in which labels LA to LE are respectively assigned to the defect candidate areas D1 to D5 is illustrated as an example.

Labeling carried out by the specifying unit 20E enables specifying of a position of each defect candidate area D in the evaluation target image 50A, the number of pixels constituting each defect candidate area D, pixel values of the pixels included in each defect candidate area D, the maximum pixel value out of the pixel values of the pixels included in each defect candidate area D, and the like. A position of each defect candidate area D in the evaluation target image 50A is represented by, for example, pixel positions of the individual pixels in each defect candidate area D to which each label L is assigned, a position coordinate of each of the pixels, the center coordinate of each defect candidate area D, or the like.

For example, for each specified defect candidate area D, the specifying unit 20E stores, in the memory unit 14, each label L, and the position of each defect candidate area D in the evaluation target image 50A, the number of pixels constituting each defect candidate area D, the pixel values of the pixels included in each defect candidate area D, and the maximum pixel value out of the pixel values of the pixels included in each defect candidate area D in association with each other. Each label L of each defect candidate area D may be treated as information that includes ID (identification information) of each label L and the position of each defect candidate area D in the evaluation target image 50A, the number of pixels constituting each defect candidate area D, the pixel values of the pixels included in each defect candidate area D, and the maximum pixel value out of the pixel values of the pixels included in each defect candidate area D.

The specifying unit 20E preferably specifies a plurality of the image areas Q that overlap within the same pattern area P out of the image areas Q in the evaluation target image 50 as the single defect candidate area D.

FIGS. 5B and 5C are explanatory diagrams illustrating examples of specifying of the defect candidate areas D. In FIGS. 5A and 5C, an evaluation target image 50B is illustrated as an example. The evaluation target image 50B (an evaluation target image 50C in FIG. 5C) is an example of the evaluation target image 50.

For example, a case is assumed that the specifying unit 20E specifies, out of the pixels included in the evaluation target image 50B, the image areas Q1 to Q4 as the image areas Q of consecutive pixels each of which has a pixel value equal to or greater than the first threshold value.

The specifying unit 20E arranges the pattern areas P specified by the pattern area specifying unit 20B at the same pixel position indicated by the pattern area P in the evaluation target image 50B, thereby virtually arranging the pattern area P in the evaluation target image 50B. In FIG. 5B, a case in which the pattern area P1 to which the label L1 is assigned and the pattern area P2 to which the label L2 is assigned are virtually arranged is illustrated as an example.

The specifying unit 20E then specifies the image areas Q that overlap within the same pattern area P out of the image areas Q1 to Q4 in the evaluation target image 50B as the single defect candidate area D.

In detail, the specifying unit 20E specifies the image areas Q that overlap within the same pattern area P. In the example illustrated in FIG. 5B, the specifying unit specifies an image area Q1, an image area Q2, and an image area Q3 as the image areas Q that overlap within the pattern area P1 to which the label L1 is assigned.

Overlapping within the pattern areas P means that at least some areas out of the image areas Q overlap within the pattern areas P. One image area Q may be arranged to overlap within a plurality of different pattern areas P. In this case, a pattern area P with the largest overlap area with the image areas Q out of the overlapping pattern areas P may be specified as the pattern area P with which the image areas Q overlap.

The specifying unit 20E then specifies image areas Q each having a distance between the center coordinates equal to or smaller than a predetermined value out of the image areas Q (image areas Q1 to Q3) that overlap within the same pattern area P1 in the evaluation target image 50B, as the single defect candidate area D. This predetermined value may be determined in advance. This predetermined value may also be changed as needed according to operation instructions given to the UI unit 18 by the user.

Furthermore, the specifying unit 20E may then specify a maximum feature area that is the image area Q with the largest feature and another image area Q having a distance from the center coordinate of the another image area Q to the center coordinate of the maximum feature area equal to or smaller than a predetermined value out of the image areas Q (image areas Q1 to Q3) that overlap within the same pattern area P1 in the evaluation target image 50B, as the single defect candidate area D. This predetermined value may be determined in advance. This predetermined value may also be changed as needed according to operation instructions given to the UI unit 18 by the user.

The features of the image areas Q may be calculated in the same manner, using the feature calculation unit 20F described later.

For example, it is assumed that the image area Q2 has the largest feature out of the image areas Q1 to Q3 that overlap within the pattern area P1. In this case, the specifying unit 20E calculates a distance between the center coordinate of the image area Q2 and the center coordinate of each of the image areas Q1 and Q3, which are other image areas Q and overlap within the pattern area P1. For example, it is assumed that a distance between the center coordinate of the image area Q2 and the center coordinate of the image area Q1 is equal to or smaller than a predetermined value. Furthermore, it is assumed that a distance between the center coordinate of the image area Q2 and the center coordinate of the image area Q3 is a value greater than the predetermined value.

In this case, as illustrated in FIG. 5C, the specifying unit 20E specifies the image area Q2 and the image area Q1 as the single defect candidate area D1. The specifying unit 20E then assigns, for example, a label LA as the label L to a defect candidate area D1 consisting of the image area Q2 and the image area Q1. Furthermore, the specifying unit 20E specifies each of the other image areas Q (image areas Q3 and Q4) as each of different defect candidate areas D (defect candidate areas D2 and D3) and assigns each of the labels L (label LB and label LC) thereto.

Thus, the specifying unit 20E may specify the image areas Q that overlap within the same pattern area P out of the image areas Q in the evaluation target image 50 as the single defect candidate area D.

Returning to FIG. 1, the explanation will be continued.

The feature calculation unit 20F calculates a feature (a feature amount) of the specified defect candidate area D in the evaluation target image 50.

The feature of the defect candidate area D is represented by a group of feature values of pixels each constituting the defect candidate area D in the evaluation target image 50. The group consisting of feature values specifically represents, for example, the distribution of feature values, the maximum value of feature values, the number of feature values, that is, an area represented by the number of pixels or a group of pixels constituting the defect candidate area D, the maximum value of a difference in pixel values between the reference image 30 and the inspection image 40 used to derive the feature values, and other values.

The feature calculation unit 20F calculates a feature of the defect candidate area D by applying filter processing to the defect candidate area D included in the evaluation target image 50 with an image processing filter.

As the image processing filter, a filter that can separate patterns and noise included in the evaluation target image 50 may be used. The pattern included in the evaluation target image 50 is an area corresponding to the pattern area P in the evaluation target image 50.

The feature calculation unit 20F uses, for example, an image processing filter, such as Gaussian Filter or difference of gaussian (DoG), as the image processing filter. The feature calculation unit 20F may also use a combination of several types of filters, such as Gaussian Filter and DoG, as the image processing filter. The feature calculation unit 20F may also use a filter in a frequency space, such as a wavelet transform, as the image processing filter.

The feature calculation unit 20F obtains a feature value of each of the pixels included in the defect candidate area D by applying filter processing to the defect candidate area D included in the evaluation target image 50 with an image processing filter. The feature calculation unit 20F calculates a feature represented by a group of feature values of the pixels included in the defect candidate area D for each defect candidate area D included in the evaluation target image 50.

The correction feature calculation unit 20G calculates a corrected feature obtained by correcting a feature with a second threshold value.

As described above, the feature is represented by a group of feature values of pixels each constituting the defect candidate area D in the evaluation target image 50.

The correction feature calculation unit 20G corrects, for each defect candidate area D in the evaluation target image 50, a feature value of a pixel out of the pixels constituting the defect candidate area D that is smaller than the second threshold value to 0. The correction feature calculation unit 20G then calculates the feature represented by a group of the corrected feature values as a correction feature.

For example, the correction feature calculation unit 20G corrects a feature value of each of the pixels each constituting the defect candidate area D by the above-described processing with the second threshold value, and calculates the sum of the corrected feature values of the pixels constituting the defect candidate area D as a correction feature of the defect candidate area D.

In this case, after smoothing, by processing, for example, a gaussian filter or the like, the corrected feature values of the pixels each included in the defect candidate area D in order to reduce noise, the correction feature calculation unit 20G may calculate the sum of feature values obtained after smoothing as the correction features for the defect candidate area D.

The correction feature calculation unit 20G may update the second threshold value at each iteration of defect estimation image generation processing performed by the evaluation target image generation unit 20C.

The defect estimation image generation processing is a series of processes performed by the specifying unit 20E, the feature calculation unit 20F, the correction feature calculation unit 20G, and the defect determination unit 20H included in the defect estimation image generation unit 20D. In detail, the defect estimation image generation processing is a series of processes of a process of specifying a defect candidate area D by the specifying unit 20E, a process of calculating a feature by the feature calculation unit 20F, a process of calculating a correction feature by the correction feature calculation unit 20G, and a process of generating a defect estimation image by the defect determination unit 20H described later, which are executed in sequence.

In the present embodiment, the defect estimation image generation unit 20D iterates the defect estimation image generation processing, which is the above-described series of processes, under the control of the iteration control unit 20I, as described later.

The correction feature calculation unit 20G sets, for example, a predetermined initial value as the second threshold value during the first-time of the defect estimation image generation processing executed on one evaluation target image 50. The initial value of the second threshold value is, for example, “0”, but is not limited to this value.

The correction feature calculation unit 20G updates the initial value of the predetermined second threshold value for each iteration of the defect estimation image generation processing. In detail, the correction feature calculation unit 20G updates the second threshold value for each iteration of the defect estimation image generation processing so that the second threshold value is proportional to at least one of the variation in the correction feature of each of the one or more defect candidate areas D included in the evaluation target image used as a processing target at this time, the maximum value of the correction feature of the one or more defect candidate areas D, and the iteration number of the defect estimation image generation processing.

The second threshold value updated by the correction feature calculation unit 20G is used as the second threshold value for the next defect estimation image generation processing.

Next, the defect determination unit 20H will be described. The defect determination unit 20H generates a defect estimation image by using the evaluation target image 50 and a correction feature of the defect candidate area D.

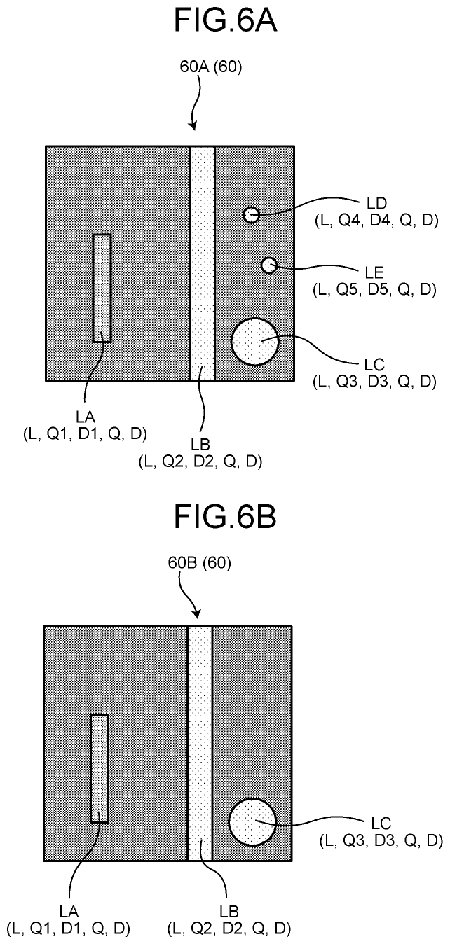

FIG. 6A is a schematic diagram illustrating an example of a defect estimation image 60. The defect estimation image 60 is an image for which a defect estimation value is specified as a pixel value for each pixel. In other words, the defect estimation image 60 is an image for which the pixel values of the evaluation target image 50 are replaced by defect estimation values.

For example, the defect determination unit 20H generates the defect estimation image 60 in which the defect estimation value corresponding to a value obtained by multiplying a pixel value of the pixel in the defect candidate area D of the evaluation target image 50 by a correction feature of the defect candidate area D to which the pixel belongs is defined for each pixel included in the defect candidate area D in the evaluation target image 50.

In detail, the defect determination unit 20H calculates the defect estimation value of a pixel at a position of a coordinate (x,y) that constitutes the defect estimation image 60 by using the following Equation (1).

E(x,y)=α×P(x,y)×W(labelF(x,y)) Equation (1)

In Equation (1), E(x,y) represents a defect estimation value of the pixel at a position of the coordinate (x,y). α represents an adjustment factor. P(x,y) represents a pixel value at the coordinate (x,y) of the evaluation target image 50. labelF(x,y) represents a correction feature of the defect candidate area D to which the pixel at the coordinate (x,y) belongs. W is a function for calculation of a weight coefficient from the correction feature of the defect candidate area D.

Out of the pixels constituting the evaluation target image 50, a defect estimation value of a pixel at a pixel position that does not belong to any defect candidate areas D is defined as a value calculated with labelF(x,y)=0.

Values of α and W may be adjusted so that a relationship of E(x,y)≤P(x,y) is satisfied.

The defect determination unit 20H may further determine the defect area based on the generated defect estimation image 60.

In detail, the defect determination unit 20H determines pixels where a defect estimation value E(x,y) of each pixel included in the generated defect estimation image 60 is equal to or greater than a fourth threshold value as a defect area. The fourth threshold value may be determined in advance. The fourth threshold value may be changed as needed according to operation instructions given to the UI unit 18 by the user.

For example, it is assumed that defect estimation values of pixels included in each of defect candidate areas D1 to D5 in a defect estimation image 60A illustrated in FIG. 6A are equal to or greater than the fourth threshold value. In this case, the defect determination unit 20H determines each of the defect candidate areas D1 to D5 as a defect area.

The defect determination unit 20H may also determine a pixel where a defect estimation value E(x,y) of each pixel included in the generated defect estimation image 60 is equal to or greater than the fourth threshold value and pixels around the pixel as a defect area. The term “pixels around the pixel” represents pixels adjacent to the pixel whose defect estimation value E(x,y) is equal to or greater than the fourth threshold value and N pixels toward a direction away from the pixel equal to or greater than the fourth threshold value and the pixels adjacent to the pixel. N is an integer of equal to or greater than 1 and may be determined in advance. N may also be changed as needed according to operation instructions given to the UI unit 18 by the user.

Furthermore, in a case in which the defect estimation value E(x,y) of each pixel included in the generated defect estimation image 60 is equal to or greater than a fifth threshold value and smaller than the fourth threshold value, and M or more consecutive pixels each of which has the defect estimation value E(x,y) within the range are arranged, the defect determination unit 20H may determine an area consisting of these pixels as a defect area. The fifth threshold value may be smaller than the fourth threshold. The fifth threshold value and a value of M may be determined in advance. The fifth threshold value and the value of M may be changed as needed according to operation instructions given to the UI unit 18 by the user.

Returning to FIG. 1, the explanation will be continued.

The iteration control unit 20I controls the defect estimation image generation unit 20D so that the defect estimation image generation processing is iterated with the defect estimation image 60 generated by the defect determination unit 20H as the evaluation target image 50. In other words, the iteration control unit 20I controls the defect estimation image generation unit 20D to perform iteration of the defect estimation image generation processing using a newly generated defect estimation image 60 as the evaluation target image 50 on one inspection image 40.

In detail, the iteration control unit 20I controls the defect estimation image generation unit 20D to use the defect estimation image 60 generated by the defect determination unit 20H as the evaluation target image 50 used in the next defect estimation image generation processing, and to iterate the defect estimation image generation processing, which is the series of processes described above, until it is determined that a predetermined termination condition is satisfied.

The termination condition may be determined in advance. Specifically, the termination condition indicates satisfying at least one condition of: the number of iterations of the defect estimation image generation processing is equal to or greater than a predetermined number; the number of defect candidate areas D included in the defect estimation image 60 is equal to or smaller than a predetermined number; or the number of times the defect estimation image 60 generated during the previous execution of the defect estimation image generation processing is matched with the defect estimation image 60 generated during the current execution of the defect estimation image generation processing is equal to or greater than the predetermined number of times.

These predetermined number of times and predetermined numbers may be set in advance. These predetermined number of times and predetermined numbers may also be changed as needed according to operation instructions given to the UI unit 18 by the user. Furthermore, the iteration control unit 20I may adjust which one or more conditions described above are used as the termination conditions depending on a condition specific to a pattern represented by the pattern area P included in the reference image 30 and the performance of the defect inspection device 10.

As the number of iterations of the defect estimation image generation processing is smaller, noise or false defects are likely to be included in the defect estimation image 60. As the number of the defect candidate areas D included in the defect estimation image 60 is greater, noise or false defects are likely to be included in the defect estimation image 60. As the number of times the defect estimation image 60 generated during the previous execution of the defect estimation image generation processing is matched with the defect estimation image 60 generated during the current execution of the defect estimation image generation processing is greater, it is highly likely that the defect estimation image 60 with higher accuracy has already been generated.

Therefore, it is possible to separate defect areas from false defect areas and noise with high accuracy by the control to iterate the defect estimation image generation processing until the iteration control unit 20I determines that the above-described processing condition is satisfied. Furthermore, adjusting which one or more conditions described above are used as the termination conditions depending on the condition specific to a pattern and the performance of the defect inspection device 10 enables efficient inspection of the defect areas.

The iteration control unit 20I controls the defect estimation image generation unit 20D to iterate the defect estimation image generation processing, so that the defect estimation image 60 generated at a stage where the termination condition is satisfied is a defect estimation image 60 in which pixels having lower defect estimation values and noise are removed as compared with a defect estimation image 60 generated at a stage where the termination condition of the defect estimation image generation processing is not satisfied.

FIG. 6A is a schematic diagram illustrating, for example, an example of a defect estimation image 60A generated at the stage where the termination condition of the defect estimation image generation processing is not satisfied. FIG. 6B is a schematic diagram illustrating an example of a defect estimation image 60B generated at the stage where the termination condition of the estimation image generation processing is satisfied. The defect estimation image 60B is an example of the defect estimation image 60.

As illustrated in FIG. 6A, the defect estimation image 60A generated at the stage where the termination condition is not satisfied includes, for example, noise or the defect candidate areas D4 and D5, which are areas where the defect estimation values are lowered by iteration of the defect estimation image generation processing, and the like. On the other hand, as illustrated in FIG. 6B, the defect estimation image 60B generated at the stage where the termination condition is satisfied does not include, for example, noise included in the defect estimation image generated at the stage where the termination condition is not satisfied or the defect candidate areas D4 and D5, which are areas where the defect estimation values are lowered by iteration of the defect estimation image generation processing.

Therefore, the iteration control unit 20I controls the defect estimation image generation unit 20D to iterate the defect estimation image generation processing, so that the defect estimation image generation unit 20D can generate the defect estimation image 60 including defect areas that can be inspected with higher accuracy.

Even in a case of areas where the defect estimation values are lowered by iteration of the defect estimation image generation processing, the areas may be required to be detected as defects, in practice. For example, the image areas Q described above may be present in the same pattern area P. At least some of these image areas Q may be areas required to be detected as defects, even in the case of areas where the defect estimation values are lowered by iteration of the defect estimation image generation processing.

Therefore, the specifying unit 20E of the defect estimation image generation unit 20D of the present embodiment specifies a plurality of the image areas Q that overlap within the same pattern area P out of the image areas Q in the evaluation target image 50 as the single defect candidate area D, as described above.

In detail, as described above, the specifying unit 20E specifies a maximum feature area that is the image area Q with the largest feature and another image area Q having a distance from the center coordinate of the another image area Q to the center coordinate of the maximum feature area equal to or smaller than a predetermined value out of the image areas Q that overlap within the same pattern area P in the evaluation target image 50, as the single defect candidate area D.

Therefore, the defect estimation image generation unit 20D can adjust areas that are likely to be the areas required to be detected as defects in advance before the process of generating the defect estimation image 60 so that the feature or correction feature has already had a large value, even though the areas where the defect estimation values are lowered, by iteration of the defect estimation image generation processing are present.

Therefore, the defect estimation image generation unit 20D of the present embodiment can generate the defect estimation image 60 including the areas that are likely to be the areas required to be detected as defects and that can be inspected with higher accuracy, even though the areas where the defect estimation values are lowered, by iteration of the defect estimation image generation processing are present.

Returning to FIG. 1, the explanation will be continued.

In a case in which the iteration control unit 20I determines that the termination condition is satisfied, the output control unit 20J outputs the defect estimation image 60 generated at the end of the iteration of the defect estimation image generation processing by the defect estimation image generation unit 20D to the UI unit 18. The output control unit 20J may also output, together with the defect estimation image 60, at least one of the inspection image 40 or the reference image 30 used in the defect estimation image generation processing of the defect estimation image 60 to the UI unit 18. The output control unit 20J may also transmit the defect estimation image 60 to an external information processing device via the communication unit 16. The output control unit 20J may also store the defect estimation image 60 in the memory unit 14.

The output control unit 20J may output a determination result of defect areas represented by the defect estimation image 60 together with the defect estimation image 60 or instead of the defect estimation image 60. A determination result of the defect areas obtained by the defect determination unit 20H can be used for the determination result. The determination result is represented by, for example, the positions of the pixels constituting the defect areas in the defect estimation image 60. The positions of the individual pixels in the defect estimation image 60 correspond to the positions of the pixels in each of the reference image 30, the inspection image 40, and the evaluation target image 50. Therefore, the output control unit 20J can output information indicating which pixel position in the inspection image 40 is defective by outputting the determination result of the defect areas represented by the defect estimation image 60.

Next, an example of a flow of information processing performed by the defect inspection device 10 of the present embodiment will be described.

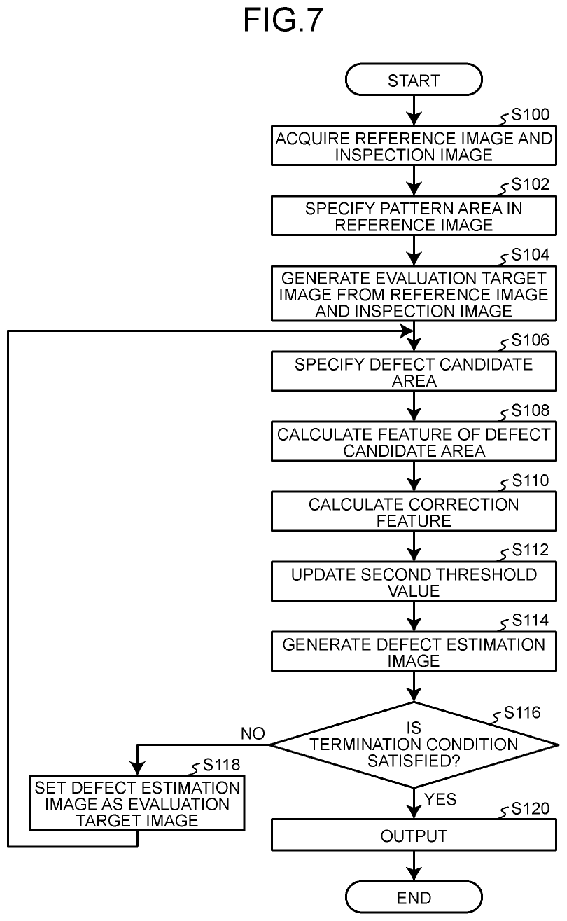

FIG. 7 is a flowchart illustrating an example of the flow of information processing performed by the defect inspection device 10 of the present embodiment.

The acquisition unit 20A acquires the reference image 30 and the inspection image 40 (step S100). The pattern area specifying unit 20B specifies the pattern area P included in the reference image 30 acquired at step S100 (step S102).

The evaluation target image generation unit 20C generates the evaluation target image 50 from the reference image 30 and the inspection image 40 acquired at step S100 (step S104).

The specifying unit 20E specifies the defect candidate areas D included in the evaluation target image 50 generated at step S104 (step S106).

The feature calculation unit 20F calculates the feature of each defect candidate area D specified at step S106 in the evaluation target image 50 generated at step S104 (step S108).

The correction feature calculation unit 20G corrects the feature calculated at step S108 with the second threshold value and calculates a correction feature (correction feature amount) (step S110).

The correction feature calculation unit 20G updates the second threshold value used for the calculation of the correction feature at step S110 (step S112).

The defect determination unit 20H generates the defect estimation image 60 by using the evaluation target image 50 generated at step S104 and the correction feature of each defect candidate area D calculated at step S110 (step S114).

The iteration control unit 20I determines whether or not the termination condition is satisfied (step S116). In a case in which it is determined that the termination condition is not satisfied (No at step S116), the processing proceeds to step S118.

At step S118, the iteration control unit 20I sets the defect estimation image 60 generated at step S114 as the evaluation target image 50 (step S118). The iteration control unit 20I controls each of the specifying unit 20E, the feature calculation unit 20F, the correction feature calculation unit 20G, and the defect determination unit 20H to perform the processing using the defect estimation image generated at step S114 as the evaluation target image 50 instead of the evaluation target image 50 generated at step S104. Then, the processing returns to step S106 described above.

Therefore, in the first defect estimation image generation processing for one evaluation target image 50 (processing of step S106 to step S114), the defect estimation image generation unit 20D uses the evaluation target image 50 generated at step S104. On the other hand, during iteration of the defect estimation image generation processing in the second and subsequent times, the defect estimation image generation unit 20D executes the defect estimation image generation processing using the defect estimation image 60 generated by the previous defect estimation image generation processing as the evaluation target image 50.

In a case in which the iteration control unit 20I determines that the termination condition is satisfied (Yes at step S116), the processing proceeds to step S120. At step S120, the output control unit 20J outputs the defect estimation image 60 generated at the end of the iteration of the defect estimation image generation processing by the defect estimation image generation unit 20D to the UI unit 18 (step S120). This routine is then terminated.

As described above, the defect inspection device of the present embodiment includes the acquisition unit the evaluation target image generation unit 20C, the defect estimation image generation unit 20D, and the iteration control unit 20I. The acquisition unit 20A acquires the inspection image 40 obtained by imaging the inspection target and the reference image 30 of the inspection target in design. The evaluation target image generation unit 20C generates the evaluation target image corresponding to the inspection image 40 and the reference image 30. The defect estimation image generation unit 20D generates the defect estimation image 60 in which a defect estimation value is defined for each pixel based on the feature of the defect candidate area D corresponding to the image area Q of the consecutive pixels each of which has the pixel value equal to or greater than the first threshold value included in the evaluation target image 50. The iteration control unit 20I controls the defect estimation image generation unit 20D to iterate the defect estimation image generation processing using the defect estimation image 60 as the evaluation target image 50.

Here, as the related art, a technique of comparing an inspection image with a reference image of the inspection target in design, and determining a defect area based on changes in edge shapes in the image has been disclosed. In addition, a technique of generating a multidimensional feature image by applying multiple filter processes to an inspection image, and detecting defects from the multidimensional feature image.

However, in the determination technique based on the changes in the edge shapes, patterns and shapes of the defects to be determined were limited. Therefore, it was difficult to determine defect areas included in an inspection image that includes defects and patterns of shapes other than those to be determined. Furthermore, in the technique using multidimensional feature images, false defects that are not defects may be detected as defects because of noise included in the inspection image, detection conditions, and other factors. In other words, it is difficult to inspect defect areas with high accuracy in the related art.

On the other hand, the defect inspection device 10 of the present embodiment performs iteration of the defect estimation image generation processing of generating the defect estimation image 60 based on the feature of the defect candidate area D included in the evaluation target image 50 generated corresponding to the inspection image 40 and the reference image 30 by using the generated defect estimation image 60 as the evaluation target image 50.

Therefore, the iteration of the defect estimation image generation processing performed by the defect inspection device 10 of the present embodiment enables generation of the defect estimation image 60 that does not contain the defect candidate area D where the defect estimation values are lowered by the iteration of the defect estimation image generation processing. In other words, the defect inspection device 10 can generate the defect estimation image 60 in which pixels have low defect estimation values and noise has been removed by iteration of the defect estimation image generation processing. The defect inspection device 10 can also prevent false defects that are not defects from being included in the defect estimation image 60. In other words, the defect inspection device 10 of the present embodiment can control the defect estimation image generation processing to be iterated, thereby separating the defect areas from false defect areas and noise with high accuracy.

Therefore, the defect inspection device 10 of the present embodiment can generate the defect estimation image including the defect areas that can be inspected with high accuracy. In other words, the defect inspection device 10 can inspect the defect areas with high accuracy by using the defect estimation image 60 including the defect areas that can be inspected with high accuracy.

Therefore, the defect inspection device 10 of the present embodiment can improve the inspection accuracy in the defect areas.

The defect inspection device 10 of the present embodiment generates the defect estimation image 60 based on the feature of the defect candidate area D included in the evaluation target image 50 generated corresponding to the inspection image 40 and the reference image 30. Therefore, in addition to the above effects, the defect inspection device 10 of the present embodiment can inspect the defect areas with high accuracy regardless of the patterns and defect shapes included in the inspection image 40.

In addition, the defect inspection device 10 of the present embodiment can reduce a computational load because the defect inspection device 10 generates the defect estimation image 60 without using a multidimensional feature image. Furthermore, the defect inspection device 10 of the present embodiment can inspect the defect areas with high accuracy and efficiency.

The defect inspection device 10 of the present embodiment generates the defect estimation image 60 using the evaluation target image 50 corresponding to the reference image 30 and the inspection image 40 without applying the filter processing directly to the inspection image 40. As described above, since the defect inspection device 10 of the present embodiment does not apply the filter processing directly to the inspection image 40, the defect estimation image 60 in which the shapes of the defects are maintained can be provided.

The correction feature calculation unit 20G of the defect inspection device 10 of the present embodiment updates the second threshold value for each iteration of the defect estimation image generation processing. In detail, the correction feature calculation unit 20G updates the second threshold value for each iteration of the defect estimation image generation processing so that the second threshold value is proportional to at least one of the variation in the correction feature of each of the one or more defect candidate areas D included in the evaluation target image 50 used as a processing target at this time, the maximum value of the correction feature of the one or more defect candidate areas D, and the iteration number of the defect estimation image generation processing.

Therefore, the correction feature calculation unit 20G can calculate the correction feature according to the noise situation included in the previously generated evaluation target image 50. Therefore, the defect inspection device 10 of the present embodiment can generate the evaluation target image 50 in which noise is further reduced by performing the iteration of the defect estimation image generation processing.

Next, an example of a hardware configuration of the defect inspection device 10 of the above-described embodiment will be described.

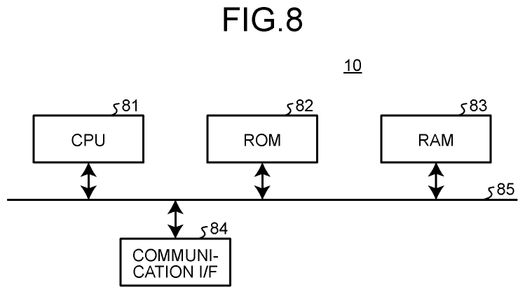

FIG. 8 is a hardware configuration diagram of an example of the defect inspection device 10 of the above-described embodiment.

The defect inspection device 10 of the above-described embodiment has a hardware configuration in which a central processing unit (CPU) 81, a read only memory (ROM) 82, a random access memory (RAM) 83, a communication I/F 84, and the like are connected to each other via a bus 85, and an ordinary computer is used.

The CPU 81 is a computing device for controlling the defect inspection device 10 of the above-described embodiment. The ROM 82 stores computer programs and the like for implementing various processes by the CPU 81. Although the CPU is used herein, graphics processing unit (GPU) may be used as a computing device for controlling the defect inspection device 10. The RAM 83 stores data required for various processes by the CPU 81. The communication I/F 84 is an interface for connection to the UI unit 18 and other units and transmitting and receiving data.

In the defect inspection device 10 of the above-described embodiment, each of the above-described functions is implemented on a computer by the CPU 81 reading computer programs from the ROM 82 onto the RAM 83 and executing the computer programs.

The computer programs for executing each of the above-described processes performed by the defect inspection device 10 of the above-described embodiment may be stored in hard disk drive (HDD). The computer programs for executing each of the above-described processes performed by the defect inspection device 10 of the above-described embodiment may be provided by being incorporated in the ROM 82 in advance.

The computer programs for executing the above-described processes performed by the defect inspection device 10 of the above-described embodiment may be provided as computer program products stored in a computer-readable storage medium such as CD-ROM, CD-R, memory card, digital versatile disc (DVD), flexible disk (FD), or other media as files in an installable format or in an executable format. The computer programs for executing the above-described processes performed by the defect inspection device 10 of the above-described embodiment may be provided by storing the computer programs in a computer connected to a network such as the Internet and downloading the computer programs via the network. The computer programs for executing the above-described processes performed by the defect inspection device 10 of the above-described embodiment may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A defect inspection device comprising:
one or more hardware processors configured to function as:
an acquisition unit that acquires an inspection image obtained by imaging an inspection target and a reference image of the inspection target in design;
an evaluation target image generation unit that generates an evaluation target image in accordance with the inspection image and the reference image;
a defect estimation image generation unit that generates, based on a feature of a defect candidate area corresponding to an image area of consecutive pixels each of which has a pixel value equal to or greater than a first threshold value and which are included in the evaluation target image, a defect estimation image for which a defect estimation value is defined for each pixel; and
an iteration control unit that controls the defect estimation image generation unit to perform iteration of defect estimation image generation processing using the defect estimation image as the evaluation target image.

2. The defect inspection device according to claim 1, wherein the defect estimation image generation unit includes:
a specifying unit that specifies the defect candidate area corresponding to the image area of the consecutive pixels each of which has a pixel value equal to or greater than the first threshold value and which are included in the evaluation target image;
a feature calculation unit that calculates a feature of the specified defect candidate area in the evaluation target image;
a correction feature calculation unit that calculates a correction feature obtained by correcting the feature with a second threshold value; and
a defect determination unit that generates the defect estimation image by using the evaluation target image and the correction feature.

3. The defect inspection device according to claim 2, wherein the iteration control unit controls the defect estimation image generation unit to use the defect estimation image generated by the defect determination unit as the evaluation target image to be used for next defect estimation image generation processing, and to iterate the defect estimation image generation processing, which is a series of processes of a process of specifying the defect candidate area, a process of calculating the feature, a process of calculating the correction feature, and a process of generating the defect estimation image in sequence, until it is determined that a predetermined termination condition is satisfied.

4. The defect inspection device according to claim 3, wherein the termination condition is at least one condition of:
a number of iterations of the defect estimation image generation processing being equal to or greater than a predetermined number;
a number of defect candidate areas included in the defect estimation image being equal to or smaller than a predetermined number; and
a number of times the defect estimation image generated during previous execution of the defect estimation image generation processing is matched with the defect estimation image generated during current execution of the defect estimation image generation processing being equal to or greater than a predetermined number of times.

5. The defect inspection device according to claim 2, wherein
the one or more hardware processors are configured to further function as a pattern area specifying unit that specifies a pattern area of consecutive pixels each of which has a pixel value equal to or greater than a third threshold value and which are included in the reference image, and
the specifying unit specifies a plurality of image areas that overlap within a same pattern area out of image areas in the evaluation target image as a single defect candidate area.

6. The defect inspection device according to claim 5, wherein the specifying unit specifies a maximum feature area that is an image area with a largest feature and an image area having a distance from a center coordinate of the image area to a center coordinate of the maximum feature area that is equal to or smaller than a predetermined value out of the plurality of image areas that overlap within the same pattern area in the evaluation target image, as the single defect candidate area.

7. The defect inspection device according to claim 3, wherein
the feature in the defect candidate area is represented by a group of feature values of pixels constituting the defect candidate area in the evaluation target image, and
the correction feature calculation unit calculates a feature obtained after the feature value of a pixel out of the pixels constituting the defect candidate area in the evaluation target image that is smaller than the second threshold value is corrected to 0, as the correction feature.

8. The defect inspection device according to claim 3, wherein the correction feature calculation unit updates an initial value of the predetermined second threshold value for each iteration of the defect estimation image generation processing.

9. The defect inspection device according to claim 8, wherein the correction feature calculation unit updates the second threshold value for each iteration of the defect estimation image generation processing such that the second threshold value is proportional to at least one of a variation in the correction feature of each of one or more defect candidate areas included in the evaluation target image, a maximum value of the correction feature of the one or more defect candidate areas, and a number of iterations of the defect estimation image generation processing.

10. The defect inspection device according to claim 2, wherein the defect determination unit generates the defect estimation image for which the defect estimation value corresponding to a value obtained by multiplying a pixel value by the correction feature of the defect candidate area to which the pixel belongs is defined for each pixel included in the defect candidate area in the evaluation target image.

11. The defect inspection device according to claim 1, wherein the evaluation target image generation unit generates a difference image between the inspection image and the reference image as the evaluation target image.

12. A defect inspection method implemented by a computer, the method comprising:
acquiring an inspection image obtained by imaging an inspection target and a reference image of the inspection target in design;
generating an evaluation target image in accordance with the inspection image and the reference image;
generating, based on a feature of a defect candidate area corresponding to an image area of consecutive pixels each of which has a pixel value equal to or greater than a first threshold value and which are included in the evaluation target image, a defect estimation image for which a defect estimation value is defined for each pixel; and
controlling iteration of defect estimation image generation processing using the defect estimation image as the evaluation target image to be performed.

13. A defect inspection computer program product having a non-transitory computer readable medium including programmed instructions stored thereon, wherein the instructions, when executed by a computer, cause the computer to perform:
acquiring an inspection image obtained by imaging an inspection target and a reference image of the inspection target in design;
generating an evaluation target image in accordance with the inspection image and the reference image;
generating, based on a feature of a defect candidate area corresponding to an image area of consecutive pixels each of which has a pixel value equal to or greater than a first threshold value and which are included in the evaluation target image, a defect estimation image for which a defect estimation value is defined for each pixel; and
controlling iteration of defect estimation image generation processing using the defect estimation image as the evaluation target image to be performed.
